(19) United States
(12) Patent Application Publication
(10) Pub. No.: US 2002/0161080 A1
(43) Pub. Date: Oct. 31, 2002

(54) Process for the stabilization of HDPE

(76) Inventors: Kurt Hoffmann, Lautertal (DE); Heinz Herbst, Lautertal-Reichenbach (DE); Rudolf Pfaendner, Rimbach/Odenwald (DE)

Correspondence Address: Patent Department, Ciba Specialty Chemicals Corporation, 540 White Plains Road, P.O. Box 2005, Tarrytown, NY, 10591-9005, US

(21) Appl. No.: 10/132,365

(22) Filed: Apr. 25, 2002

Related U.S. Application Data
(63) Continuation of application No. 08/704,643, filed on Sep. 12, 1996, now abandoned.
Application No. 08/704,643 is a 371 of international application No. PCT/EP95/00897, filed on Mar. 10, 1995.

(30) Foreign Application Priority Data
Mar. 22, 1994 (CH) 864/94-5

(51) Int. Cl. C08K 5/52

(52) U.S. Cl. 524/127

(57) ABSTRACT

High-density polyethylene (HDPE) which experiences a reduction in molecular weight during processing and is obtainable by means of catalysts of the Ziegler-Natta type can be stabilized against thermo-oxidative degradation by addition of a combination of a sterically hindered phenol and an organic phosphite or phosphonite and calcium oxide.

The invention relates to stabilized high-density polyethylene (HDPE), as obtainable by means of catalysts of the Ziegler-Natta type, to a stabilization process, and to the use of a stabilizer mixture in this process.

The processing and use of bulk plastics (for example polypropylene, polyethylene or PVC) are impossible without the addition of stabilizers such as antioxidants and light stabilizers, etc. In recent years, advantageous processing and long-term stabilizers for fresh materials (for example polypropylene or polyethylene) have proven to be combinations of sterically hindered phenols and organic phospites and phosphonites.

Some organic phosphites are very sensitive to moisture and tend towards hydrolysis, causing a drop in effectivness. EP-A-0 400 454 proposes stabilizing organic phosphites derived from a pentaerythrityl phosphite by addition of a metal soap, an alkali metal oxide or an alkali metal salt. In U.S. Pat. No. 4,443,572, a pentaerythrityl phosphite is stabilized by addition of an alkaline earth metal oxide. Furthermore, FR-A-82 09635 describes copolymers of ethylene and another olefin to which a mixture of a phenolic antioxidant, an organic phosphite and an alkaline earth metal oxide have been added.

The object of the present invention was to provide a novel stabilizer system by means of which fresh HDPE material, which experiences a reduction in molecular weight during processing, having improved stability compared with that on addition of known stabilizers can be obtained.

The invention thus relates to stabilized high-density polyethylene (HDPE) which experiences a reduction in molecular weight during processing, as obtained, in particular, by means of catalysts of the Ziegler-Natta type, comprising a mixture, preferably from 0.05 to 15% by weight, of a) at least one sterically hindered phenol, b) at least one organic phosphite or phosphonite and c) calcium oxide.

The novel stabilizer combination gives an unexpected, synergistic reduction in the drop in molecular weight during processing. Thus, during multiple extrusion (processing stability), the addition of the novel stabilizer combination results in an only very slight increase in the melt flow rate. Furthermore, the addition of the novel stabilizer combination gives very good long-term heat stability.

For the purposes of the present invention, HDPE is obtainable by polymerization by means of organometallic mixed catalysts (Ziegler-Natta catalysts), for example by precipitation polymerization. Combinations of metals from sub-groups IV to VIII with metals from main groups I to IV of the Periodic Table are usually used. The reaction is carried out under atmospheric pressure or a superatmospheric pressure of up to about 5 bar at temperatures below 150° C. in an inert solvent, for example aromatics or alkane or cycloalkane hydrocarbons. In industry, catalyst combinations of trialkylaluminium compounds, alkylaluminium halides and, for example, magnesium chloride, triethylaluminium, aluminium trichloride, diethylaluminium chloride, tris(2-methylpropyl)aluminium, or diethylmagnesium and titanium(III) chloride, titanium(IV) chloride, titanic esters and, for example vanadium trichloride or tribromide, vanadium tetrachloride, zirconium tetrachloride or tetrabromide, VOCl₂, VOCl₃, vanadium trisacetylacetonate, dichlorotitanocene, dichlorozirconocene, a titanium(III) chloride/methyltitanium trichloride mixture or magnesium chloride-modified titanium(IV) chloride catalysts have proven particularly successful. It is also possible to prepare HDPE by gas-phase polymerization. In this case, the catalyst is a transition-metal compound (for example titanium(IV) chloride) applied to high-purity, anhydrous magnesium compounds. The polymerization is carried out at a pressure of about 3.5 MPa and a temperature of 85-100° C.

The a:b weight ratio is preferably from 20:1 to 1:20, in particular from 10:1 to 1:10, very particularly preferably from 4:1 to 1:4. The (a+b):c weight ratio is preferably from 10:1 to 1:20, in particular from 5:1 to 1:10, very particularly preferably from 3:1 to 1:3.

The HDPE is preferably mixed with from 0.05 to 5% by weight, particularly preferably from 0.1 to 2% by weight, very particularly preferably from 0.1 to 1% by weight, of the mixture of a, b and c.

The sterically hindered phenols used as component a are known stabilizers against thermooxidative ageing of plastics, in particular polyolefins. The sterically hindered phenols contain, for example, at least one group of the formula I

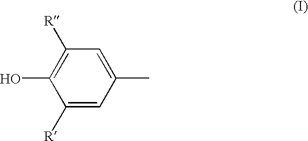

in which R′ is hydrogen, methyl or tert-butyl, and R″ is unsubstituted or substituted alkyl or unsubstituted or substituted alkylthioalkyl.

Particularly preferred compounds as component a are those of the formula II

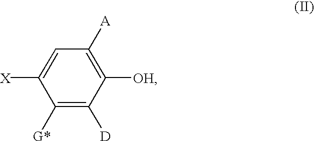

in which

A is hydrogen, C₁-C₂₄alkyl, C₅-C₁₂cycloalkyl, phenyl-C₁-C₄alkyl, phenyl, —CH₂—S—R₂₅ or

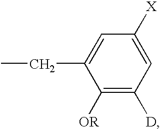

D is C₁-C₂₄alkyl, C₅-C₁₂cycloalkyl, phenyl-C₁-C₄-alkyl, phenyl or —CH₂—S—R₂₅,

X is hydrogen, C₁-C₁₈alkyl, —CₐH₂ₐ—S_{q}—R₂₆, —C_{b}H_{2b}—CO—OR₂₇, —C_{b}H_{2b}—CO—N(R₂₉)(R₃₀), —CH₂N(R₃₄)(R₃₅),

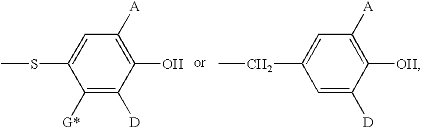

R is hydrogen or a group of the formula —CO—CH═CH₂,

G* is hydrogen or C₁-C₁₂alkyl,

R₂₅ is C₁-C₁₈alkyl, phenyl, —(CH₂)_{c}—CO—OR₂₈ or —CH₂CH₂OR₃₃,

R₂₆ is hydrogen, C₁-C₁₈alkyl, phenyl, benzyl,

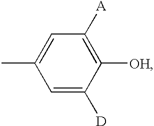

—(CH2)_{c}—CO—OR₂₈ or —CH₂—CH₂—OR₃₃,

R₂₇ is C₁-C₃₀alkyl, —CHR₃₁—CH₂—S—R₃₂,

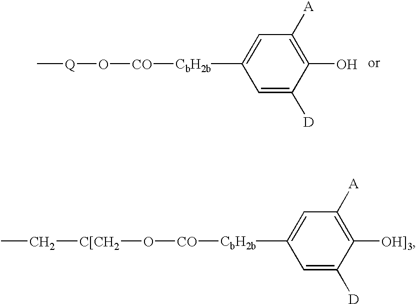

in which Q is C₂-C₈alkylene, C₄-C₆thiaalkylene or —CH₂CH₂(OCH₂CH₂)_{d}—,

R₂₈ is C₁-C₂₄alkyl,

R₂₉ is hydrogen, C₁-C₁₈alkyl or cyclohexyl,

R₃₀ is C₁-C₁₈alkyl, cyclohexyl, phenyl, C₁-C₁₈alkyl-substituted phenyl or one of the groups

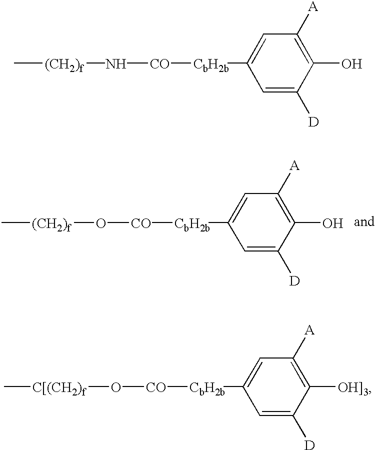

or R₂₉ and R₃₀ together are C₄-C₈alkylene, which may be interrupted by —O— or —NH—,

R₃₁ is hydrogen, C₁-C₄alkyl or phenyl,

R₃₂ is C₁-C₁₈alkyl,

R₃₃ is hydrogen, C₁-C₂₄alkyl, phenyl, C₂-C₁₈alkanoyl or benzoyl,

R₃₄ C₁-C₁₈alkyl, cyclohexyl, phenyl, C₁-C₁₈alkyl-substituted phenyl or

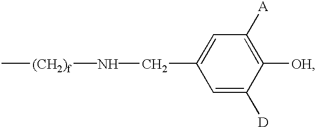

R₃₅ is hydrogen, C₁-C₁₈alkyl, cyclohexyl, or

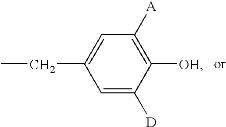

R₃₄ and R₃₅ together are C₄-C₈alkylene, which may be interrupted by —O— or —NH—, a is 0, 1, 2 or 3, bis 0, 1, 2 or 3, c is 1 or 2, d is 1 to 5, f is 2 to 8 and q is 1, 2, 3 or 4.

Preference is given to compounds of the formula II in which

A is hydrogen, C₁-C₈alkyl, cyclohexyl, phenyl, —CH₂—S—C₁-C₁₈alkyl or

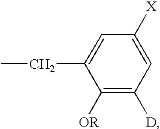

D is C₁-C₈alkyl, cyclohexyl, phenyl or —CH₂—S—C₁-C₁₈alkyl,

X is hydrogen, C₁-C₈alkyl, —CₐH₂ₐ—S_{q}—R₂₆, —C_{b}H_{2b}—CO—OR₂₇, —CH₂N(R₃₄)(R₃₅),

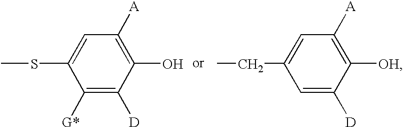

R₂₆ is C₁-C₁₂alkyl, phenyl or —(CH₂)_{c}—O—OR₂₈,

R₂₇ is C₁-C₁₈alkyl,

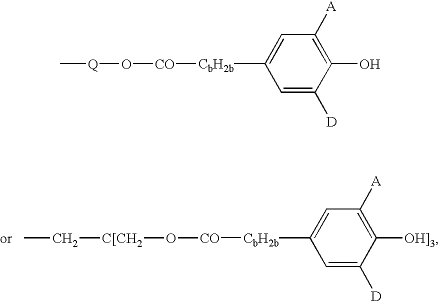

in which Q is C₂-C₈alkylene, —CH₂—CH₂—CH₂CH₂— or —CH₂CH₂(OCH₂CH₂)_{d}—,

R₂₈ is C₁-C₁₈alkyl,

R₃₄ and R₃₅, independently of one another, are hydrogen or C₁-C₁₂alkyl, or

R₃₄ and R₃₅ together are C₄-C₈alkylene, which may be interrupted by —O— or —NH—,

a is 1 or 2, b is 1 or 2, c is 1 or 2, and d is 1, 2 or 3.

Examples of sterically hindered phenols of this type are:

2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-i-butylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, 2,6-dinonyl-4-methylphenol, 2,6-di-tert-butyl-4-methoxyphenol, 2,5-di-tert-butylhydroquinone, 2,5-di-tert-amylhydroquinone, 2,6-diphenyl-4-octa-decyloxyphenol, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-do-decylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl] terephthalate, 1,3,5-tris(3,5-di-tert-butyl-4-hydroxybenzyl)-2,4,6-trimethylbenzene, bis(3,5-di-tert-butyl-4-hydroxybenzyl) sulfide, isooctyl 3,5-di-tert-butyl-4-hydroxybenzylmercaptoacetate, bis(4-tert-butyl-3-hydroxy-2,6-dimethylbenzyl) dithioterephthalate, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, dioctadecyl 3,5-di-tert-butyl-4-hydroxybenzylphosphonate and the calcium salt of monoethyl 3,5-di-tert-butyl-4-hydroxybenzylphosphonate.

Component a is particularly preferably a compound containing at least one group of the formula

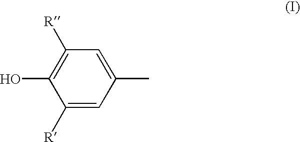

in which R′ is methyl or tert-butyl; and

R″ is unsubstituted or substituted alkyl or unsubstituted or substituted alkylthioalkyl.

Examples of such hindered phenols are the esters of β-(3,5-di-tert-butyl-4-hydroxyphenyl)propionic acid and of β-(5-tert-butyl-4-hydroxy-3-methylphenyl)propionic acid with monohydric or polyhydric alcohols, for example with methanol, octanol, octadecanol, 1,6-hexanediol, neopentyl glycol, thiodiethylene glycol, diethylene glycol, triethylene glycol, pentaerythritol, tris(hydroxyethyl) isocyanurate,

N,N′-bis(hydroxyethyl)oxalamide, and the amides of these acids, for example

N,N′-bis(3,5-di-tert-butyl-4-hydroxyphenylpropionyl)hexamethylenediamine,

N,N′-bis(3,5-di-tert-butyl-4-hydroxyphenylpropionyl)trimethylenediamine and

N,N′-bis(3,5-di-tert-butyl-4-hydroxyphenylpropionyl)hydrazine.

Other particularly preferred compounds are:

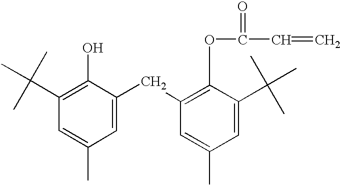

### {2-(1,1-dimethylethyl)-6-[[3-(1,1-dimethylethyl)-2-hydroxy-5-methylphenyl]methyl]-4-methylphenyl 2-propenoate}

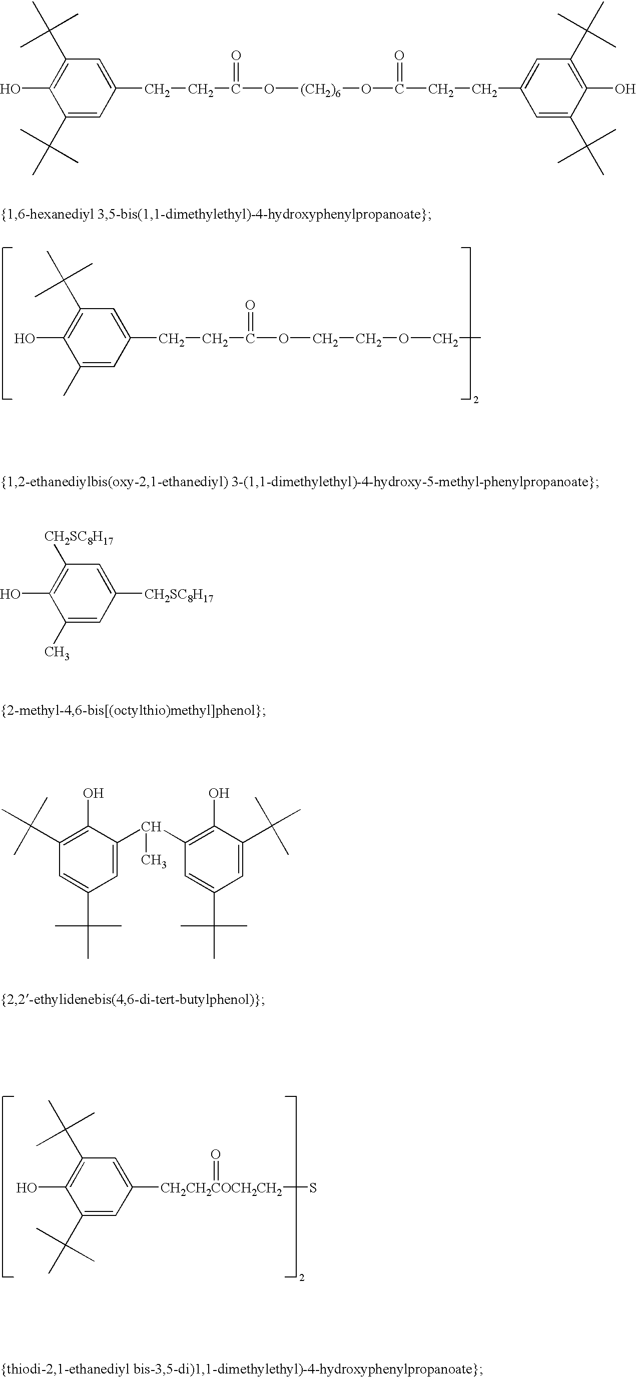

### {4,4′,4″-[(2,4,6-trimethyl-1,3,5-phenyltriyl)tris(methylene)]tris[2,6-bis(1,1-dimethylethyl) phenol}

Component a is very particularly preferably pentaerythrityl, octyl or octadecyl β-(3,5-di-tert-butyl-4-hydroxyphenyl)propionate.

Component a is preferably used in an amount from 0.01 to 3% by weight, based on HDPE.

The organic phosphites and phosphonites to be used according to the invention as component b are likewise known as stabilizers for plastics. They are used, in particular, as processing stabilizers for polyolefins.

The phosphites to be used according to the invention conform, for example, to the formulae

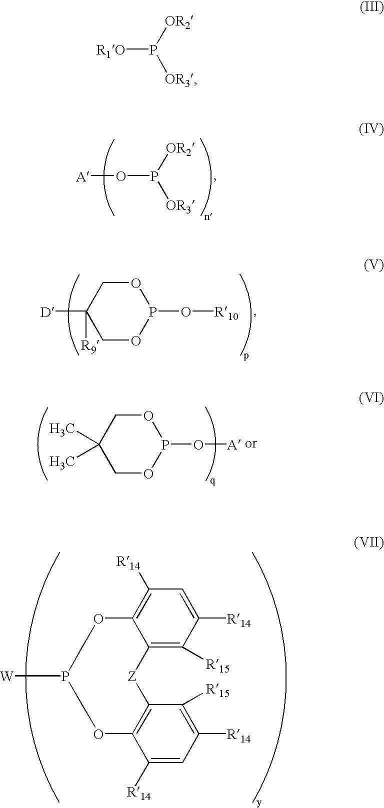

in which

R′₁, R′₂ and R₃, independently of one another, are alkyl having 1 to 18 carbon atoms, alkyl having 1 to 18 carbon atoms which is substituted by halogen, —COOR₄′, —CN or —CONR₄′R₄′, alkyl having 2 to 18 carbon atoms which is interrupted by —S—, —O— or —NR′₄—, cycloalkyl having 5 to 8 carbon atoms, phenyl or naphthyl, phenyl or naphthyl which is substituted by halogen, 1 to 3 alkyl radicals or alkoxy radicals having a total of 1 to 18 carbon atoms, 2,2,6,6-tetramethylpiperid-4-yl, N-allyl- or N-benzyl- or N-alkyl-2,2,6,6-tetramethylpiperid-4-yl having 1 to 4 carbon atoms in the alkyl moiety or N-alkanoyl-2,2,6,6-tetramethylpiperid-4-yl having 1 to 4 carbon atoms in the alkyl moiety, or N-alkylene-2,2,6,6-tetramethylpiperidyl or N-alkylene-4-alkoxy-2,2,6,6-tetramethyl-piperidyl having 1 to 3 carbon atoms in the alkylene moiety and 1 to 18 carbon atoms in the alkoxy moiety,

R′₄ or the radicals R₄′ are, independently of one another, hydrogen, alkyl having 1 to 18 carbon atoms, cycloalkyl having 5 to 12 carbon atoms or phenylalkyl having 1 to 4 carbon atoms in the alkyl moiety,

n′ is 2, 3 or 4,

A′, if n′ or q is 2, is alkylene having 2 to 12 carbon atoms, alkylene having 2 to 12 carbon atoms which is interrupted by —S—, —O— or —NR′₄—, in which R′₄ is as defined above, or a radical of the formula

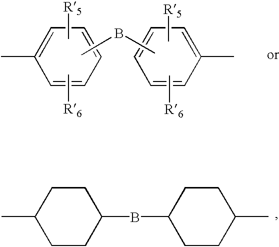

A′, if n′ or q is 3, is a radical of the formula —CᵣH₂ᵣ₋₁— or N(CH₂CH₂)₃, in which r is 5 or 6,

A′, if n′ is 4, is the radical of the formula C(CH₂)₄,

R′₅ and R′₆ independently of one another, are hydrogen or alkyl having 1 to 8 carbon atoms,

B is a radical of the formula —CH₂—, —CHR′₄—, —CR′₁R′₄—, —S— or a direct bond, in which R′₁, and R′₄ are as defined above,

p is 1 or 2,

D′ is methyl if p is 1 and —CH₂OCH₂— if p is 2,

R′₉ is methyl, and R′₁₀ is as defined for R′₁,

q is 2 or 3,

y is 1, 2 or 3,

W, if y is 1, is alkyl having 1 to 18 carbon atoms, a radical of the formula —OR′₁₆, —NR′₁₇R′₁₈ or fluorine,

W, if y is 2, is a radical of the formula —O—A″—O— or

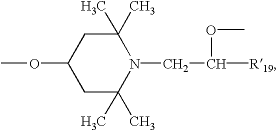

W, if y is 3, is a radical of the formula R′₄C(CH₂O)₃, N(C₂H₄O)₃ or N(C₃H₆O)₃, in which R′₄ is as defined above,

R′₁₆ is as defined for R′₁,

R′₁₇ and R′₁₈, independently of one another, are alkyl having 1 to 18 carbon atoms, benzyl, cyclohexyl, a 2,2,6,6-tetra- or 1,2,2,6,6-pentamethylpiperid-4-yl radical, or R′₁₇ and R′₁₈ together form butylene, pentylene, hexylene or the radical of the formula —CH₂CH₂—O—CH₂CH₂—,

A″ is as defined for A′ if n′ is 2,

R′₁₉ is hydrogen or methyl, the substituents R′₁₄, independently of one another, are hydrogen, alkyl having 1 to 9 carbon atoms or cyclohexyl,

R′₁₅ is hydrogen or methyl and

Z is a direct bond, —CH₂—, —C(R′₁₄)₂— or —S—, in which the substituents R′₁₄ are identical or different and are as defined above.

Particularly suitable phosphites of the formula (III) are those in which R′₁, R′₂ and R′₃, independently of one another, are alkyl having 1 to 18 carbon atoms, phenyl, phenyl which is substituted by 1 to 3 alkyl radicals having a total of 1 to 18 carbon atoms, or 2,2,6,6-tetramethylpiperid-4-yl, in particular, independently of one another, phenyl which is substituted by 1 to 3 alkyl radicals having a total of 1 to 12 carbon atoms.

Particularly suitable phosphites of the formula (IV) are those in which A′ is preferably, if n′ is 2, alkylene having 2 to 12 carbon atoms, —CH₂CH₂—O—CH₂CH₂—, —CH₂CH₂—O—CH₂CH₂O—CH₂CH₂— or —CH₂CH₂—NR′₄—CH₂CH₂—, or A′, if n′ is N(CH₂CH₂)₃, where R′₄ is alkyl having 1 to 4 carbon atoms.

Particularly suitable phosphites of the formula (V) are those in which p is 1, D′ is methyl, R′₉ is methyl and R′₁₀ is phenyl which is substituted by 1 to 3 alkyl radicals having a total of 1 to 18 carbon atoms.

Particularly suitable phosphites of the formula (VII) are those in which W, if y is 1, is a radical of the formula —OR′₁₆, —NR′₁₇R′₁₈ or fluorine, or W, if y is 2, is a radical of the formula —O—CH₂CH₂—NR′₄—CH₂CH₂—O—, or W, if y is 3, is a radical of the formula N(CH₂CH₂O)₃, where R′₁₆ is alkyl having 1 to 18 carbon atoms, R′₁₇ and R′₁₈, independently of one another, are alkyl having 1 to 18 carbon atoms, cyclohexyl or benzyl, or R′₁₇ and R′₁₈ together form a piperidyl, morpholinyl or hexamethyleneimino radical, and R′₄ is as defined above, Z is a direct bond, —CH₂— or —CHCH₃—, and the two substituents R′₁₄, independently of one another, are alkyl having 1 to 4 carbon atoms, and, in particular, if y is 1, W is 2-ethylhexoxy or fluorine, R′₁₄ is tert-butyl, R′₁₅ is hydrogen and Z is —CH₂— or —CH(CH₃)—, or W, if y is 2, is a radical of the formula —O—CH₂CH₂—NCH₃—CH₂CH₂—O—.

Preference is given to phosphites and phosphonites which have relatively low hydrolytic sensitivity, for example trilauryl phosphite, trioctadecyl phosphite, distearyl pentaerythrityl diphosphite or tristearyl sorbityl triphosphite.

Preference is furthermore given to aromatic phosphites and phosphonites, these contain an aromatic hydrocarbon radical, for example a phenyl radical. Examples thereof are triphenyl phosphite, diphenyl alkyl phosphites, phenyl dialkyl phosphites and, in particular, tris(nonylphenyl) phosphite, tris(2,4-di-tert-butylphenyl) phosphite, bis(2,4-di-tert-butylphenyl) pentaerythrityl diphosphite, tetrakis(2,4-di-tert-butylphenyl)-4,4′-biphenylene diphosphonite and 2,2′-ethylidenebis(4,6-di-tert-butylphenyl) fluorophosphite.

Of particular interest are phosphites and phosphonites containing, as structural units, the P—O—Ar group, where Ar is an aromatic radical, preferably a phenyl radical, which contains an alkyl substituent in the ortho-position to the P—O—C bond. Suitable alkyl substituents are C₁-C₁₈alkyl radicals or C₅-C₇cycloalkyl radicals, preferably C₁-C₄alkyl radicals, in particular tert-butyl (indicated by

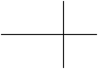

in the formulae).

The following phosphites and phosphonites are particularly preferred: tris(2,4-di-tert-butylphenyl) phosphite;

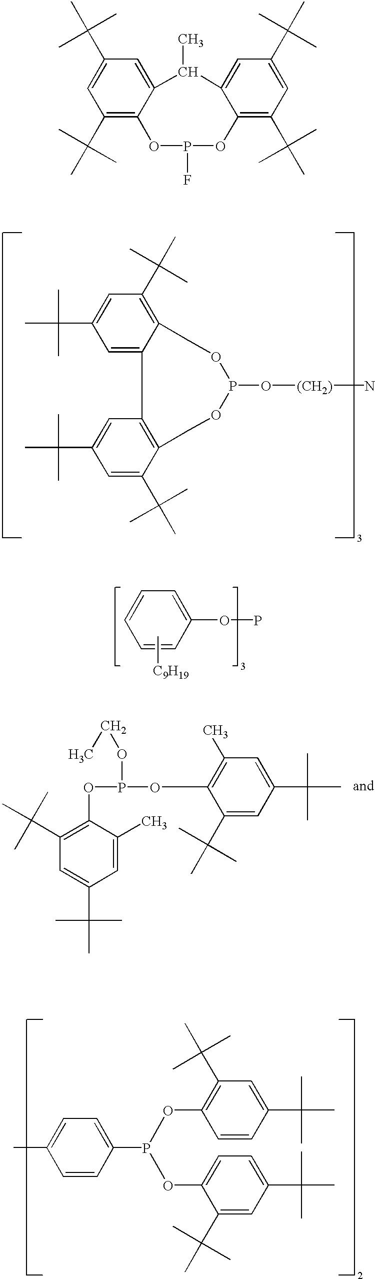

Component b is very particularly preferably tris(2,4-di-tert-butylphenyl) phosphite or

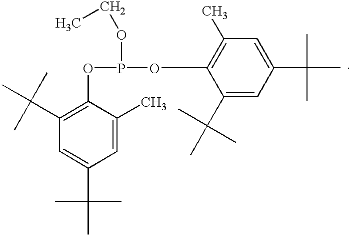

Component b is preferably used in an amount of from 0.01 to 3% by weight, based on HDPE.

Component c is calcium oxide, which is also taken to include substances which only comprise some calcium oxide, for example MgO/CaO mixtures formed, for example, by ignition of dolomite, and Ca(OH)₂/CaO mixtures. The calcium oxide can be employed in the form of powder, but also in coated form or on a support material or alternatively mixed with an inert powder, for example polyethylene wax.

Component c is preferably used in an amount of from 0.005 to 10% by weight, based on HDPE.

If desired, a mixture of various compounds for a and b can also be employed.

The present invention furthermore relates to the use of a mixture for stabilizing HDPE which experiences a reduction in molecular weight during processing and is obtained, in particular, by means of catalysts of the Ziegler-Natta type, which mixture comprises a) at least one sterically hindered phenol, b) at least one organic phosphite or phosphonite and c) calcium oxide.

The present invention furthermore relates to a process for the stabilization of HDPE which experiences a reduction in molecular weight during processing and is obtained, in particular, by means of catalysts of the Ziegler-Natta type, which comprises adding a) at least one sterically hindered phenol, b) at least one organic phosphite or phosphonite and c) calcium oxide to the HDPE.

Preferred stabilizer mixtures and preferred process embodiments correspond in their components and mixing ratios to the preferences described in greater detail for the HDPE stabilized in accordance with the invention.

The addition of these combinations to the HDPE enables thermoplastic processing with reduced degradation and extends the service life of the materials produced from the HDPE.

The incorporation of the mixture in accordance with the novel process can be accomplished by adding the individual components, but alternatively by premixing the components in powder form, granular form or compacted form. It is also possible to prepare a mixture with an inert support, for example a mixture in LDPE as a masterbatch. The incorporation is usually carried out before or during shaping; these and other useful modes of incorporation are known to the person skilled in the art.

The stabilizing action of the mixture of a, b and c, in particular the long-term stability, may be increased synergistically by the addition of compounds known as thiosynergists. These are aliphatic thioethers, in particular esters of thiodipropionic acid. Examples thereof are the lauryl, stearyl, myristyl and tridecyl esters of thiodipropionic acid and distearyl disulfide. These thiosynergists are preferably used in an amount of from 0.1 to 1% by weight, based on HDPE.

It is also possible to add further suitable stabilizers from the lactate series, for example calcium lactate or calcium stearoyl-2-lactylate, or benzofurans, for example

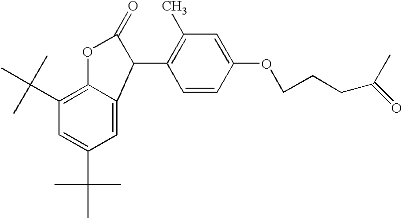

or described in U.S. Pat. No. 4,325,863, U.S. Pat. No. 4,338,244, U.S. Pat. No. 5,175,312, U.S. Pat. No. 5,216,052, U.S. Pat. No. 5,252,643, DE-A-4 316 611, DE-A-4 316 622, DE-A-4 316 876, EP-A-0 589 839 or EP-A-0 591 102, and 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxy-phenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one.

Other suitable stabilizers are chroman derivatives of the formula

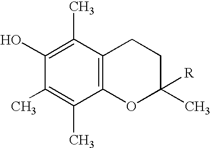

where R is —(CH₂)₃—CH(CH₃)—(CH₂)₃—CH(CH₃)—(CH₂)₃—CH—(CH₃)₂ or —CH₂—CH₂—O—C(O)—Z, and

Z is C₁-C₁₈alkyl, —CH₂—CH₂—S—C₁-C₁₈alkyl or

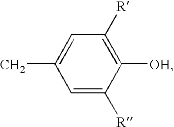

where R′ and R″ are hydrogen, methyl or tert-butyl, for example α-tocopherol, β-tocopherol, γ-tocopherol, δ-tocopherol and mixtures thereof (vitamin E).

If the HDPE article is also required to have high light stability, the addition of one or more light stabilizers is recommended. Suitable light stabilizers for this purpose are, in particular, those from the series consisting of benzophenones, benzotriazoles, oxanilides and sterically hindered amines. Examples of such compounds are:

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octoxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-yl phenol]; transesterification product of 2-[3′-tert-butyl-5′-(2-methoxycarbonylethyl)-2′-hydroxyphenyl]benzotriazole with polyethylene glycol 300; [R—CH₂CH₂—COO(CH2)₃)₂ where R=3′-tert-butyl-4′-hydroxy-5′-2H-benzotriazol-2-yl phenyl.

2.2. 2-Hydroxybenzophenones, for example the 4-hydroxy, 4-methoxy, 4-octoxy, 4-decyloxy, 4-dodecyloxy, 4-benzyloxy, 4,2′,4′-trihydroxy and 2′-hydroxy-4,4′-dimethoxy derivatives.

2.3. Esters of unsubstituted or substituted benzoic acids, for example 4-tert-butyl-phenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl and isooctyl α-cyano-β,β-diphenylacrylate, methyl α-carbomethoxycinnamate, methyl and butyl α-cyano-β-methyl-p-methoxycinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethylbutyl)phenol], such as the 1:1 and 1:2 complexes, if desired with additional ligands, such as n-butylamine, triethanolamine or N-cyclohexyldiethanolamine, nickel dibutyldithiocarbamate, nickel salts of monoalkyl esters, such as the methyl or ethyl esters, of 4-hydroxy-3,5-di-tert-butylbenzylphosphonic acid, nickel complexes of ketoximes, such as of 2-hydroxy-4-methylphenyl undecyl ketoxime, and nickel complexes of 1-phenyl-4-lauroyl-5-hydroxypyrazole, if desired with additional ligands.

2.6 Sterically hindered amines, for example bis(2,2,6,6-tetramethylpiperidyl) sebacate, bis(2,2,6,6-tetramethylpiperidyl) succinate, bis(1,2,2,6,6-pentamethylpiperidyl) sebacate, bis(1,2,2,6,6-pentamethylpiperidyl) n-butyl-3,5-di-tert-butyl-4-hydroxybenzylmalonate, the product of the condensation of 1-hydroxyethyl-2,2,6,6-tetramethyl-4-hydroxypiperidine and succinic acid, the product of the condensation of N,N′-bis(2,2,6,6-tetramethyl-4-piperidyl)hexamethylenediamine and 4-tert-octylamino-2,6-dichloro-1,3,5-s-triazine, tris(2,2,6,6-tetramethyl-4-piperidyl) nitrilotriacetate, tetrakis(2,2,6,6-tetramethyl-4-piperidyl) 1,2,3,4-butanetetraoate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl) sebacate, bis(1-octyloxy-2,2,6,6-tetramethylpiperidyl) succinate, the product of the condensation of N,N′-bis(2,2,6,6-tetramethyl-4-piperidyl)hexamethylenediamine and 4-morpholino-2,6-dichloro-1,3,5-triazine, the product of the condensation of 2-chloro-4,6-di(4-n-butylamino-2,2,6,6-tetramethylpiperidyl)-1,3,5-triazine and 1,2-bis(3-amino-propylamino)ethane, the product of the condensation of 2-chloro-4,6-di(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione and 3-dodecyl-1-(1,2,2,6,6-pentamethyl-4-piperidyl)pyrrolidine-2,5-dione.

2.7. Oxalamides, for example 4,4′-dioctyloxyoxanilide, 2,2′-dioctyloxy-5,5′-di-tert-butyloxanilide, 2,2′-didodecyloxy-5,5′-di-tert-butyloxanilide, 2-ethoxy-2′-ethyloxanilide, N,N′-bis(3-dimethylaminopropyl)oxalamide, 2-ethoxy-5-tert-butyl-2′-ethyloxanilide and mixtures thereof with 2-ethoxy-2′-ethyl-5,4′-di-tert-butyloxanilide, and mixtures of o- and p-methoxy- and of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butoxypropoxy)phenyl]-4,6-bis(2,4-dimethylphenyl)-1,3,5-triazine, 2-[2-hydroxy-4-(2-hydroxy-3-octyloxypropoxy)phenyl]-4,6-bis(2,4-dimethylphenyl)-1,3,5-triazine.

Preference is given to light stabilizers from classes 2.1, 2.6 and 2.7, for example light stabilizers of the Chimassorb 944, Chimassorb 119, Tinuvin 234, Tinuvin 312, Tinuvin 622 and Tinuvin 770 type.

The light stabilizers are preferably added in an amount of from 0.01 to 2% by weight, in particular from 0.05 to 0.5% by weight, based on HDPE. The light stabilizers are preferably a combination of a benzotriazole and a sterically hindered amine.

If necessary other conventional plastics additives can be added to the HDPE, for example fillers, such as sawdust or mica, reinforcing agents, such as glass fibres, glass beads or mineral fibres, pigments, plasticizers, lubricants, such as metal stearates or laurates, flameproofing agents, antistatics or blowing agents. Such additions depend on the intended use of the HDPE.

The HDPE stabilized in this way can be used for a wide variety of purposes known to the person skilled in the art.

The HDPE can also be employed as a mixture with other plastics, for example in a coextrusion process, or in the form of a blend.

The examples below illustrate the novel process in greater detail. Here as in the remainder of the description, parts and percentages are by weight, unless stated otherwise.

### EXAMPLES 1 and 2

Fresh HDPE material in the form of granules (Hostalen® GF 7650 P1) is homogenized in a mixer with the stabilizers listed in Table 1 and subsequently extruded five times one after the other in a single-screw extruder (temperature 250° C.). The melt flow rate (190° C., 10 kg) is determined in accordance with DIN 53735M (ISO 1133/12) after the 1st, 3rd and 5th extrusions.

The stabilized granules from the first extrusion are converted into test specimens at 250° C. in an injection-moulding machine. These test specimens are subjected to artificial ageing at 120° C., the brittleness of the sample being determined as a function of the ageing duration. Table 1 shows the ageing time in days before the sample breaks.

TABLE 1
Multiple extrusion (temperature 250° C.) of HDPE

| | | Melt flow rate after | | | Fracture |
|---|---|---|---|---|---|
| | | 1st | 3rd | 5th | after |
| | Stabilization | extrusions | [190° C./10 kg] | | [days] |
| A | no additives | 6.69 | 7.18 | 7.72 | 5 |
| B | 0.07 AO-1 + 0.13% P1 | 7.12 | 7.58 | 8.08 | 131 |
| C | 0.04% AO-1 + 0.08% | 7.06 | 7.11 | 7.65 | 107 |
| | P-1 + 0.08% Ca stearate | | | | |
| Ex. 1 | 0.04% AO-1 + 0.08% | 6.74 | 6.80 | 6.84 | >150 |
| | P-1 + 0.08% CaO | | | | |
| Ex. 2 | 0.05% AO-1 + 0.05% | 6.84 | 6.86 | 7.04 | * |
| | P-1 + 0.10% CaO | | | | |

*not determined

The novel stabilized samples exhibit only a slight increase in melt flow index after repeated extrusion. Degradation reactions and decomposition of the polymer cause the melt flow index to increase. In addition, the artificial ageing values show the advantageous improvement in the long-term stability with the novel stabilizer mixture.

In the above examples, the following stabilizers are used:

AO-1 Pentaerythrityl ester of β-(3,5-di-tert-butyl-4-hydroxyphenyl)propionic acid

P-1 Tris-(2,4-di-tert-butylphenyl) phosphite

What is claimed is:

1. Stabilized high-density polyethylene (HDPE) which experiences a reduction in molecular weight during processing, comprising a mixture, preferably from 0.05 to 15% by weight, of a) at least one sterically hindered phenol, b) at least one organic phosphite or phosphonite and c) calcium oxide.

2. HDPE according to claim 1, as obtained by means of catalysts of the Ziegler-Natta type.

3. HDPE according to claim 1, wherein the a:b weight ratio is from 20:1 to 1:20 and the (a+b):c weight ratio is from 10:1 to 1:20.

4. HDPE according to claim 1, wherein the a:b weight ratio is from 10:1 to 1:10 and the (a+b):c weight ratio is from 5:1 to 1:10.

5. HDPE according to claim 1, comprising from 0.05 to 5% by weight of the mixture of a, b and c.

6. HDPE according to claim 1, wherein component a is a compound containing at least one group of the formula 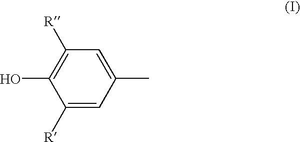
in which R′ is hydrogen, methyl or tert-butyl; and R″ is substituted or unsubstituted alkyl or substituted or unsubstituted alkylthioalkyl.

7. HDPE according to claim 1, wherein component a is a compound selected from

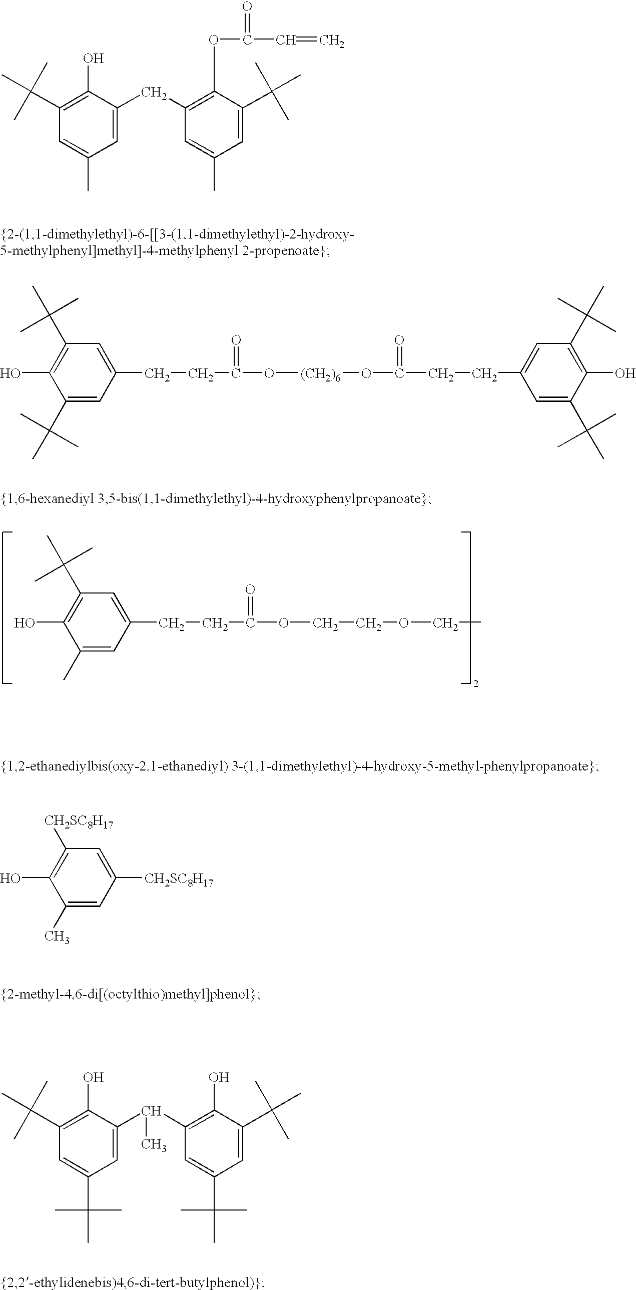

8. HDPE according to claim 1, wherein component a is the pentaerythrityl, octyl or octadecyl ester of β-(3,5-di-tert-butyl-4-hydroxyphenyl)propionic acid.

9. HDPE according to claim 1, wherein component b is a phosphonite or phosphite of the formula 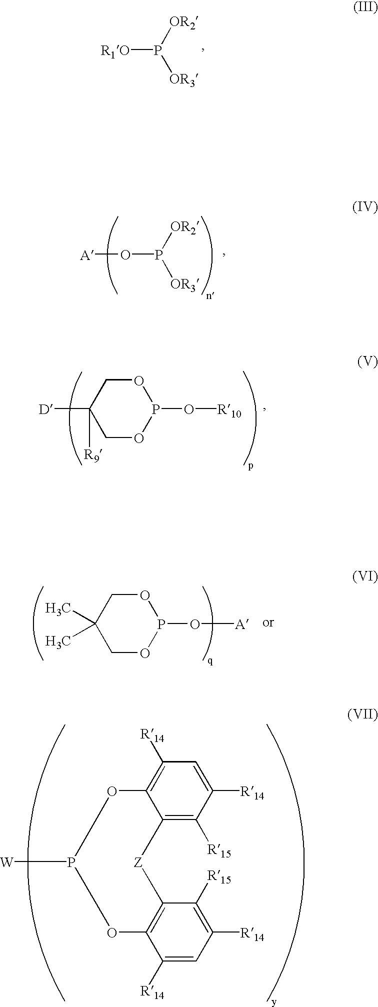
in which
R′₁, R′₂ and R′₃, independently of one another, are alkyl having 1 to 18 carbon atoms, alkyl having 1 to 18 carbon atoms which is substituted by halogen, —COOR₄′, —CN or —CONR₄′R₄′, alkyl having 2 to 18 carbon atoms which is interrupted by —S—, —O— or —NR′₄—, cycloalkyl having 5 to 8 carbon atoms, phenyl or naphthyl, phenyl or naphthyl which is substituted by halogen, 1 to 3 alkyl radicals or alkoxy radicals having a total of 1 to 18 carbon atoms, 2,2,6,6-tetramethylpiperid-4-yl, N-allyl- or N-benzyl- or N-alkyl-2,2,6,6-tetramethylpiperid-4-yl having 1 to 4 carbon atoms in the alkyl moiety or N-alkanoyl-2,2,6,6-tetramethylpiperid-4-yl having 1 to 4 carbon atoms in the alkyl moiety, or N-alkylene-2,2,6,6-tetramethylpiperidyl or N-alkylene-4-alkoxy-2,2,6,6-tetramethylpiperidyl having 1 to 3 carbon atoms in the alkylene moiety and 1 to 18 carbon atoms in the alkoxy moiety,
R′₄ or the radicals R₄′are, independently of one another, hydrogen, alkyl having 1 to 18 carbon atoms, cycloalkyl having 5 to 12 carbon atoms or phenylalkyl having 1 to 4 carbon atoms in the alkyl moiety,
n′ is 2, 3 or 4,
A′, if n′ or q is 2, is alkylene having 2 to 12 carbon atoms, alkylene having 2 to 12 carbon atoms which is interrupted by —S—, —O—or —NR′₄—, in which R′₄ is as defined above, or a radical of the formula 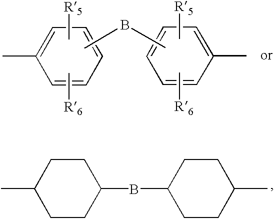
A′, if n′ or q is 3, is a radical of the formula —CᵣH₂ᵣ₋₁— or N(CH₂CH₂)₃, in which r is 5 or 6,
A′, if n′ is 4, is a radical of the formula C(CH₂)₄,
R′₅ and R′₆, independently of one another, are hydrogen or alkyl having 1 to 8 carbon atoms,
B is a radical of the formula —CH₂—, —CHR′₄—, —CR′₁R′₄—, —S— or a direct bond, in which R′₁, and R′₄ are as defined above,
p is 1 or 2,
D′ is methyl if p is 1 and —CH₂OCH₂— if p is 2,
R′₉ is methyl, and R′₁₀ is as defined for R′₁,
q is 2 or 3,
y is 1, 2 or 3,
W, if y is 1, is alkyl having 1 to 18 carbon atoms, a radical of the formula —OR′₁₆, —NR′₁₇R′₁₈ or fluorine,
W, if y is 2, is a radical of the formula —O—A″—O— or 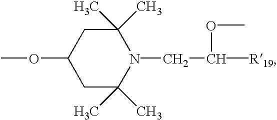
W, if y is 3, is a radical of the formula R₄C(CH₂O)₃, N(C₂H₄O)₃ or N(C₃H₆O)₃,
in which R′₄ is as defined above,
R′₁₆ is as defined for R′₁,
R′₁₇ and R′₁₈, independently of one another, are alkyl having 1 to 18 carbon atoms, benzyl, cyclohexyl, a 2,2,6,6-tetra- or 1,2,2,6,6-pentamethylpiperid-4-yl radical, or R′₁₇ and R′₁₈ together form butylene, pentylene, hexylene or the radical of the formula —CH₂CH₂—O—CH₂CH₂—,
A″ is as defined for A′, if n′ is 2,
R′₁₉ is hydrogen or methyl, the substituents R′₁₄, independently of one another, are hydrogen, alkyl having 1 to 9 carbon atoms or cyclohexyl,
R′₁₅ is hydrogen or methyl and
Z is a direct bond, —CH₂—, —C(R′₁₄)₂— or —S—, in which the substituents R′₁₄ are identical or different and are as defined above.

10. HDPE according to claim 1, wherein component b is an aromatic phosphite or phosphonite.

11. HDPE according to claim 1, wherein component b is tris(2,4-di-tert-butylphenyl)phosphite or

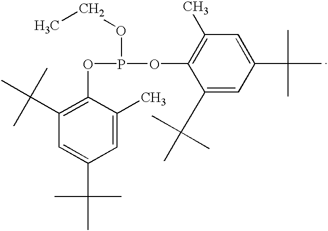

12. HDPE according to claim 1, wherein, in addition, a thiosynergist from the series consisting of the esters of thiodipropionic acid is added to the HDPE.

13. HDPE according to claim 1, wherein, in addition, at least one light stabilizer from the series consisting of the benzophenones, benzotriazoles, oxanilides and sterically hindered amines is added to the HDPE.

14. HDPE according to claim 1, wherein, in addition, at least one light stabilizer from the series consisting of the benzophenones, benzotriazoles, oxanilides and sterically hindered amines is added to the HDPE, where the amount of the light stabilizer(s) is from 0.01 to 2% by weight, based on HDPE.

15. Use of a stabilizer mixture comprising a) at least one sterically hindered phenol, b) at least one organic phosphite or phosphonite and c) calcium oxide for the stabilization of high-density polyethylene (HDPE) which experiences a reduction in molecular weight during processing.

16. A process for the stabilization of high-density polyethylene (HDPE) which experiences a reduction in molecular weight during processing, which comprises adding a) at least one sterically hindered phenol, b) at least one organic phosphite or phosphonite and c) calcium oxide to the polyethylene.
